(19) United States
(12) Patent Application Publication
(10) Pub. No.: US 2014/0255803 A1
(43) Pub. Date: Sep. 11, 2014

(54) GRAPHENE SUPPORTED BIFUNCTIONAL CATALYSTS

(71) Applicant: Wayne State University, Detroit, MI (US)

(72) Inventors: K. Y. Simon Ng, West Bloomfield, MI (US); Steve O. Salley, Grosse Pointe Park, MI (US); Kapila Wadumesthrige, Southfield, MI (US)

(73) Assignee: WAYNE STATE UNIVERSITY, Detroit, MI (US)

(21) Appl. No.: 14/349,250

(22) PCT Filed: Oct. 9, 2012
(86) PCT No.: PCT/US2012/059318

§ 371 Date: Apr. 2, 2014

Related U.S. Application Data
(60) Provisional application No. 61/547,339, filed on Oct. 14, 2011.

(51) Int. Cl. H01M 4/86

(52) U.S. Cl. CPC H01M 4/8615
USPC 429/406; 429/405

(57) ABSTRACT

The present disclosure discloses graphene supported bifunctional catalysts and metal-air batteries comprising the same. In one aspect, a metal-air battery comprises a metal anode, a cathode, an electrolyte disposed between the metal anode and the cathode, and a catalyst on the cathode. The catalyst reduces both the charge overpotential and discharge overpotential of the battery. The catalyst is disposed on a graphene support.

This application claims priority to U.S. Provisional Patent Application No. 61/547,339, filed Oct. 14, 2011, the entirety of which is hereby incorporated by reference.

### FIELD

The present disclosure relates to novel graphene supported bifunctional catalysts and metal-air batteries comprising the same. More specifically, the present disclosure relates to graphene nanosheet supported bifunctional catalysts for high cycle life Li-air batteries.

### BACKGROUND

Environmental concerns associated with using fossil fuels, combined with the need for energy security, have spurred great interest in generating electrical energy from renewable sources. Of renewable sources, solar and wind energy are among the cleanest, most abundant and readily available. However, solar and wind are not constant and reliable sources of power. Electrical energy storage is an approach to eliminate this variability and improve the reliability and efficiency of the current electrical grid.

### BRIEF SUMMARY

In one aspect, a metal-air battery comprises a metal anode, a cathode, an electrolyte disposed between the metal anode and the cathode, and a catalyst on the cathode. The catalyst reduces both the charge overpotential and discharge overpotential of the battery. The catalyst is disposed on a graphene support.

In another aspect, a catalyst comprises a metal and a graphene support on which the metal is disposed. Preferably, the metal is selected from the group consisting of Pt, Au, and combinations thereof. The metal is capable of reducing both the charge overpotential and discharge overpotential of a metal-air battery.

In yet another aspect, a catalyst comprises a composition of formula, AₘBₙOₚ, wherein m is 1-5, n is 1-5 and p is 1-5. A is a divalent metal or rare earth element and B is a tetrahedral metal, and O is oxygen. The composition is capable of reducing both the charge overpotential and discharge overpotential of a metal-air battery. The catalyst also comprises a graphene support on which the composition is disposed.

### BRIEF DESCRIPTION OF THE FIGURES

FIG. 1 illustrates the SEM image of graphene nanosheets (GNS)

FIG. 2 illustrates the XRD pattern of GNS (A) and the Raman spectrum of GNS (B). For comparison, Raman spectrum of graphite is also included in (B).

FIG. 3 illustrates the nitrogen adsorption-desorption isotherm of GNS (A) and the nitrogen adsorption-desorption isotherm of Ketjan Black carbon (KB) (B).

FIG. 4 illustrates the discharge (A) and charge (B) curves of a graphene based Li-air single cell.

FIG. 5 illustrates the comparison of discharge capacity and voltaic efficiency of graphene based and highly porous carbon based Li-air cells.

FIG. 6 illustrates the SEM image with EDX spectrum.

FIG. 7 illustrates the XRD spectrum of Pt/GNS.

FIG. 8 illustrates the comparison of discharge capacity and total energy efficiency of GNS vs. Pt/GNS Li-air cells.

FIG. 9 illustrates the first discharge and charge curves at 50 mAh/g until 100% depth of discharge (DoD) (A) and efficiencies and discharge capacity at 100 mAh/g with 70-80% DoD (B) of La₁₋ₓCeₓFe_{1-y}Mn_{y}O₃/(X=0-1 and Y=0-1) GNS Li-air cells.

FIG. 10 illustrates the electrochemical impedance spectroscopy (EIS) as a function of cycle numbers.

### DETAILED DESCRIPTION

Secondary or rechargeable batteries as energy storage devices garner more attention today than at any time in human history due to the pressure to achieve efficient and economical electrification of vehicles and storage of intermittent wind and solar energy. The specific energy of state-of-the art rechargeable Li-ion battery packs has reached 100-120 Wh/kg for automotive propulsion applications, and further engineering optimization using currently available chemistry may yield up to about 50% higher values (˜180 Wh/kg). However, this is still deemed insufficient to support the long term goals set by USABC in terms of full range (300 miles) electric vehicles because the required ˜75 kWh battery would weigh at least 400 kg and thus compromise the vehicle efficiency. Therefore, further advances in specific energy are needed but are limited by low capacities of the lithium intercalation compounds used in the cathodes.

Metal-air batteries have been shown to be low-cost, high energy density energy storage in the laboratory but suffer from drastically limited cycle life and low efficiency at the discharge and recharge cathode half-reactions. Metal-air batteries, or metal-oxygen batteries, comprises aqueous and non-aqueous electrolytes. One property of metal-air batteries compared to other batteries is that the cathode active material, oxygen, is not stored in the battery. When the battery is exposed to the environment, oxygen enters the cell through the oxygen diffusion membrane and porous air electrode and is reduced at the surface of the catalytic air electrode, forming peroxide ions and/or oxide ions in non-aqueous electrolytes or hydroxide anions in aqueous electrolytes. When the anode is lithium and non-aqueous electrolyte is used, these peroxide and/or oxide anions react with cationic species in the electrolyte and form lithium peroxide (Li₂O₂) or lithium oxide (Li₂O). The metal anode in metal-air batteries can be, for example, Fe, Zn, Al, Mg, Ca, or Li.

It has been shown that metal/air batteries have much higher specific energy than that achieved by lithium metal oxide/graphite batteries. Lithium-air batteries are attractive because the Li/O₂ redox couple has the highest specific energy among all known electrochemical couples. When only lithium is considered and oxygen is absorbed from the surrounding air environment, the battery has a specific energy of 11,972 Wh/kg or 11,238 Wh/kg if the reaction product is lithium peroxide (Li₂O₂) or lithium oxide (Li₂O), respectively. With internally carried oxygen, the specific energy is still as high as 3,622 Wh/kg or 5,220 Wh/kg if the reaction product is lithium peroxide (Li₂O₂) or lithium oxide (Li₂O), respectively. Even considering a more than 50% weight contribution from other inactive materials (including the air electrode, separator, electrolyte, and packaging), the specific energy of the lithium/air battery still has a capacity an order of magnitude larger than that of conventional lithium ion batteries.

Table 1 below lists the theoretical cell voltages and specific energies obtained when an oxygen electrode is coupled with various metal anodes. The parameters in Table 1 suggest that the Li-air battery could be the ideal candidate for energy storage devices. Various factors affect the performance of Li/air batteries. These factors include air electrode formulation, electrolyte composition, viscosity, O₂ solubility, and pressure, among others.

TABLE 1
Characteristic Electrochemical Data of Metal-Air Cells.

| | Electro- | Theoretical | Theoretical | Practical |
|---|---|---|---|---|
| | chemical | cell voltage | specific energy | operating |
| Metal | equivalent of | with O₂ | of metal oxygen | voltage metal- |
| anode | metal [Ahkg⁻¹] | electrode [V] | couple [Whkg⁻¹] | oxygen [V] |
| Li | 3861 | 3.3 | 12741 | 2.4 |
| Ca | 1337 | 3.4 | 4547 | 2.0 |
| Mg | 2205 | 3.1 | 6837 | 1.4 |
| Al | 2980 | 2.7 | 8046 | 1.6 |
| Zn | 820 | 1.6 | 1312 | 1.1 |
| Fe | 960 | 1.3 | 1248 | 1.0 |
| Cd | 478 | 1.2 | 572 | 0.9 |

One approach which could achieve at least 4-fold higher energy efficiency is by replacing the Li intercalation cathodes with the catalytically active oxygen electrodes, forming the so-called Li-air (oxygen) battery, which has the highest specific energy among all known electrochemical couples. Typically, Li-air batteries comprise a metallic lithium anode, an electrolyte comprising a dissolved lithium salt in an aprotic solvent, and a porous air cathode composed of large surface area carbon. During the discharge of the cells, the electrons flow through an external circuit and reduce incoming oxygen at the cathode/solution interface. By virtue of the presence of lithium ions in solution, the products of reaction at the cathode are lithium peroxide (Li₂O₂) and possibly Li₂O. The electrochemical process can be described as: 2 Li+O₂→Li₂O₂ (Oxygen Reduction Reaction, ORR). The open circuit voltage, E₀, of the cell is within 2.9-3.1 V. At higher applied potentials (E>E₀), the reaction above can be reversed, i.e., lithium metal is plated out on the anode, and O₂ is evolved at the cathode. Li₂O₂→2Li+O₂ (Oxygen Evolution Reaction, OER).

The nominal voltage of this cell during discharge is approximately 2.6-2.7 V, which is significantly less than E₀. The discharge overpotential η_{dis} is primarily due to the slow kinetics of the ORR. Current Li-air cells exhibit even larger charge overpotential (η_{cha}), i.e., the charging voltage is considerably higher than E₀ and is about 4.2 to 4.7 V. This corresponds to low cycle electrical energy efficiency, currently on the order of 60-70%. To be practical, stationary energy storage batteries should exhibit “round-trip” energy efficiencies greater than 75%. Since it has been known that the anode reaction (Li to Li+) is extremely fast, η_{dis} is apparently limited by a kinetic activation barrier in the cathode chemistry. The increase in η_{dis} with current density makes achieving reasonable power density from Li-air batteries difficult. Thus, effective catalysts for the discharge reaction, especially at high currents, are necessary to reduce these activation barriers. In addition, the high charge overpotential (slower kinetics of the OER) (η_{cha}) limits the rechargeability of Li air batteries and demonstrates the need for a catalyst to speed up the charging reaction as well. The present disclosure describes the development of a bifunctional oxygen electrode catalyst suitable for the non-aqueous medium under consideration.

When only lithium is considered and oxygen is absorbed from the surrounding air environment, the battery has a specific energy of 11,972 Wh/kg in non-aqueous electrolyte systems. However, Li-air systems suffer from large discharge overpotential (η_{dis}) and charge overpotential (η_{cha}) due to slow kinetics in the oxygen reduction reaction (ORR) and in the oxygen evolution reaction (OER). This corresponds to low cycle life and low electrical energy efficiency, currently on the order of 60-70%. The detailed mechanisms underlying these high over voltages are currently not fully understood, but can be substantially reduced by incorporating appropriate catalysts. At the air-electrodes (currently porous carbon cathodes), insoluble Li₂O₂ is thought to be formed via the oxygen reduction reaction (ORR). There is some evidence that, with catalysts present, Li₂O₂ will undergo the oxygen evolution reaction (OER) at sufficiently high applied recharge voltages so that the aprotic configuration could be the basis for an electrically rechargeable Li-air battery. However, the insoluble nature of Li₂O₂ in organic electrolytes makes them more prone to clogging the porous structure of the air electrodes. Although the theoretical discharge capacity of the Li-air cell is extremely high, the practical capacity is much lower and is always cathode limited.

A first challenge in designing efficient Li-air battery is developing an efficient and low cost bifunctional catalyst, which reduces both charge overpotential and discharge overpotential. Several bifunctional catalyst systems have been studied, such as electrolytic MnO₂, α-MnO₂ nanowires, Co₃O₄, Fe₂O₃, and CoFe₂O₄. These bifunctional catalyst systems have demonstrated initial discharge capacities as high as 3000 mAh/g but declined rapidly after only a few cycles. A steady discharge potential of 2.6 V vs. Li+/Li was observed for these catalysts. However, a charge voltage range from 4 to 4.7 V was observed, depending on the type of the catalyst used. It was demonstrated that bifunctional Pt—Au nanoparticles loaded onto Vulcan carbon were shown to enhance the ORR and OER with round trip efficiency of 77%. This PtAu/C system demonstrated a discharge capacity of 1200 mAh/g at a current density of 100 mA/g with the lowest charging voltage (3.5 V) and highest round-trip efficiency for Li-air cells. However, the cycle life of this system was not well studied. In almost all cases, mesoporous carbon has been used as the support for the metal nanoparticles. Such mesoporous carbon supported electrode catalysts have shown quite moderate performance in Li-air batteries, and several major obstacles arising from the carbonaceous air cathodes, such as carbon oxidation in both charge and discharge processes, remain to be overcome if the cycling efficiency and cycle life of Li-air batteries are to be improved.

A second challenge is the design of a high surface area and chemically stable support for a bifunctional catalyst, which would prevent oxidation during charging, especially at high charge voltages. For practical applications of air cathodes, it is preferable to choose a carbon support with a microstructure providing large surface area and pore volume to facilitate a Li/O₂ reaction and to hold a maximum amount of discharge products, which is proportional to the battery capacity per gram of carbon. Among porous carbon materials, Super P, Ketjan Black carbon and Vulcan carbon with high surface area and pore volumes have been used successfully to achieve high capacity air cathodes. However, during the charge cycle, oxygen is generated in a highly reactive form, causing highly corrosive conditions to the conductive support materials as well as to the carbonate electrolytes. Particularly, high surface area carbon materials used as a conductive support are severely attacked and oxidized (evolving CO₂) under anodic conditions. This suggests that the electrochemical stability of the air cathode support material is a challenge in the development of practical Li-air systems.

As an alternative to highly porous conventional carbon, single walled carbon nanotubes (SWCNT) can be used as support materials for the air electrode. For example, graphene nanosheets (GNS) can be used as cathode support material. GNS was shown as a better support with some catalytic properties compared to Vulcan XC-72 carbon. An initial discharge capacity of 2332 mAh/g with an average charge potential of 3.97 V vs Li+/Li were observed for the GNS based Li-air system. A limited cycling study of GNS (up to only five cycles) showed better performance than Vulcan XC-72 carbon. GNS was also demonstrated as a metal free catalyst support for Li-air batteries. Under a low current density of 0.5 mA/cm², these Li-air batteries showed performance comparable to a system with Pt/C up to fifty cycles. However, there is still no viable Li-air system with acceptable discharge capacity, round trip efficiency, and high cycle life.

The present disclosure provides Li-air batteries with improved capacity retention during cycling. With the promising stability and enhanced conductivity observed in graphene, the present disclosure provides Li-air batteries with bifunctional catalysts incorporated into a graphene support. It was demonstrated that graphene in Li-air batteries can be used as chemically stable, high surface area support material for air cathodes with reduced η_{dis}. Graphene nanosheets (GNS) were shown as an electrochemically stable, highly conductive support for bifunctional catalyst in Li-air cells. The present disclosure also provides the synthesis of novel, low cost bifunctional catalysts of the pervoskite type with the chemical composition La_{0.5}Ce_{0.5}Fe_{0.5}Mn_{0.5}O₃, which catalyzes the ORR and OER reactions in a working Li-air cell.

According to one embodiment of the present disclosure, a metal-air battery comprises a metal anode, a cathode, an electrolyte disposed between the metal anode and the cathode, and a catalyst on the cathode. The catalyst reduces both the charge overpotential and discharge overpotential of the battery. The catalyst is disposed on a graphene support.

The metal anode can be made of Fe, Zn, Al, Mg, Ca, Li, or combinations thereof. Preferably, the metal anode is made of Li, more preferably, a lithium metal foil. The cathode is preferably a porous cathode. Preferably, the porous cathode comprises large surface area carbon with a surface area in the range of about 200-3000 m²/g. In one example, the porous cathode and the graphene support comprise the same material. Preferably, the graphene support comprises graphene nanosheets.

According to one embodiment, the catalyst is preferably selected from the group consisting of Pt, Au, Ag, and the combinations thereof. In one example, the catalyst is Pt, and preferably Pt nanoparticles. In another example, the catalyst is Au. Preferably, the catalyst comprises both Pt and Au.

According to another embodiment, the catalyst comprises a composition of formula AₘBₙOₚ, wherein m is 1-5, n is 1-5 and p is 1-5. A is a divalent metal or rare earth element and B is a tetrahedral metal and O is oxygen. Preferably, each A is independently selected from the group consisting of Ce, Ca, Sr, Pb, and any rare earth element. Preferably, each B is independently selected from the group consisting of Ti, Fe, Ni, and Mo. Preferably, the catalyst comprises Ce.

More preferably, the catalyst comprises La₁₋ₓCeₓFe_{1-y}Mn_{y}O₃, wherein x is 0-1 and y is 0-1. Even more preferably, the catalyst comprises La_{0.5}Ce_{0.5}Fe_{0.5}Mn_{0.5}O₃.

According to another embodiment of the present disclosure, a catalyst comprises a metal and a graphene support on which the metal is disposed. Preferably, the metal is selected from the group consisting of Pt, Au, and combinations thereof. The metal is capable of reducing both the charge overpotential and discharge overpotential of a metal-air battery.

Preferably, the graphene support comprises graphene nanosheets. In one example, the metal is Pt, and preferably, Pt nanoparticles. In another example, the metal is Au. Preferably, the metal comprises both Pt and Au.

According to yet another embodiment of the present disclosure, a catalyst comprises a composition of formula, AₘBₙOₚ, wherein m is 1-5, n is 1-5 and p is 1-5. A is a divalent metal or rare earth element and B is a tetrahedral metal. The composition is capable of reducing both the charge overpotential and discharge overpotential of a metal-air battery. The catalyst also comprises a graphene support on which the composition is disposed.

Preferably, each A is independently selected from the group consisting of Ce, Ca, Sr, Pb, and any rare earth element. Preferably, each B is independently selected from the group consisting of Ti, Fe, Ni, and Mo. Preferably, the composition comprises Ce.

More preferably, the composition comprises La₁₋ₓCeₓFe_{1-y}Mn_{y}O₃, wherein x is 0-1 and y is 0-1. Still more preferably, the composition comprises La_{0.5}Ce_{0.5}Fe_{0.5}Mn_{0.5}O₃.

According to still yet another embodiment of the present disclosure, the bifunctional catalysts comprise a non-precious metal catalyst formulation with Perovskite (ABO₃) composition, where A is one or more divalent or multivalent metal ions, such as Ce, Ca, Sr, Pb and rare earth elements, and B is one or more tetrahedral metals, such as Ti, Fe, Ni, Mo, for maximizing the rechargeability of Li-air batteries. The incorporation of Ce onto these Perovskite structures decreases the undesirable formation of Li₂O which could occur during discharge if the system is starved in O₂ and which would inhibit rechargeability. Since the ORR and OER reaction proceeds at the three phase boundary of catalyst-electrolyte-gas, it is important to expand the surface area in contact with the electrolyte and oxygen molecules. Lower catalyst loading, better electronic conductivity and higher corrosion stability and preparation and deposition of catalysts as nanopowders would improve contact at the three phase boundary preparation of gas diffusion electrodes with various designs. Different catalyst preparation methods such as co-precipitation, sol-gel, reverse micelle and electrochemical deposition techniques could be used to synthesize nanoscale catalysts.

### EXAMPLES

### Materials Characterization

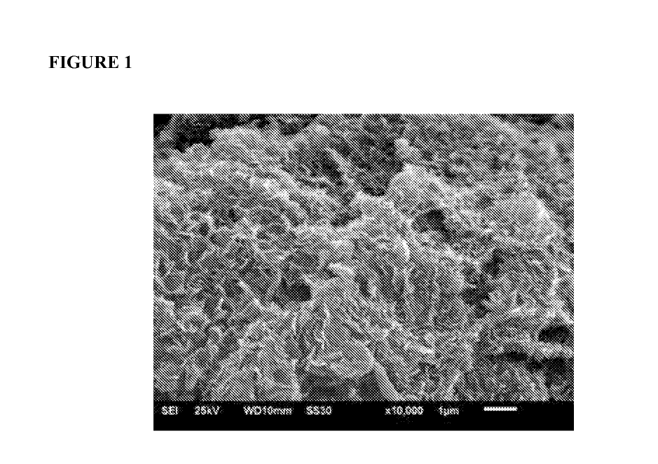

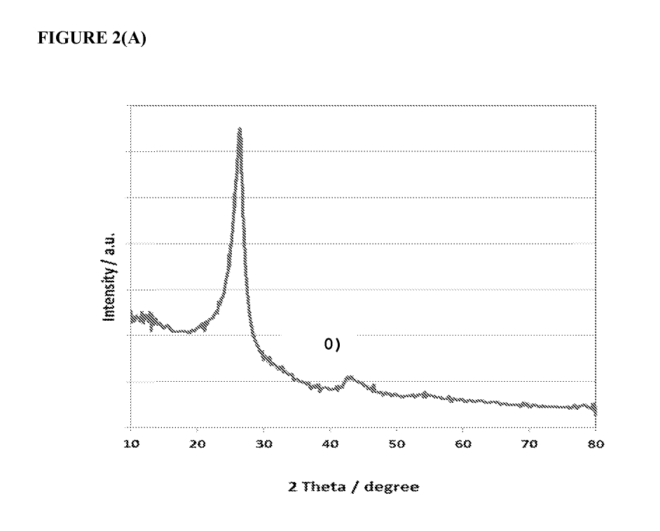

Referring to FIG. 1, the morphologies of the as-prepared GNS were observed by SEM. The as-prepared GNS comprises the characteristic wrinkle-like thin nanosheets. The X-ray diffraction pattern of as-prepared GNS is shown in FIG. 2(A). The as-prepared GNS displays both a broad (002) peak and weak (100) peak, implying the breaking of the interplanar carbon bonds of the pristine graphite and the formation of graphene nanosheets. FIG. 2(B) shows the Raman spectrum of the as-prepared GNS and that of graphite. The characteristic sharp D line of crystalline graphite is clearly visible. Two typical Raman peaks of carbon were observed at 1340 and 1585 cm⁻¹, corresponding to the D line and G line, respectively. The D line is stronger than the G line, and the D/G intensity ratio in the spectrum is significantly higher than that of well-crystallized graphite, indicating the decrease of the size of the in-plane sp² domains and partially disordered crystal structure of graphene nanosheets. The surface area and microstructure of the carbon sources play an important role in the electrochemical performance of Li-air batteries.

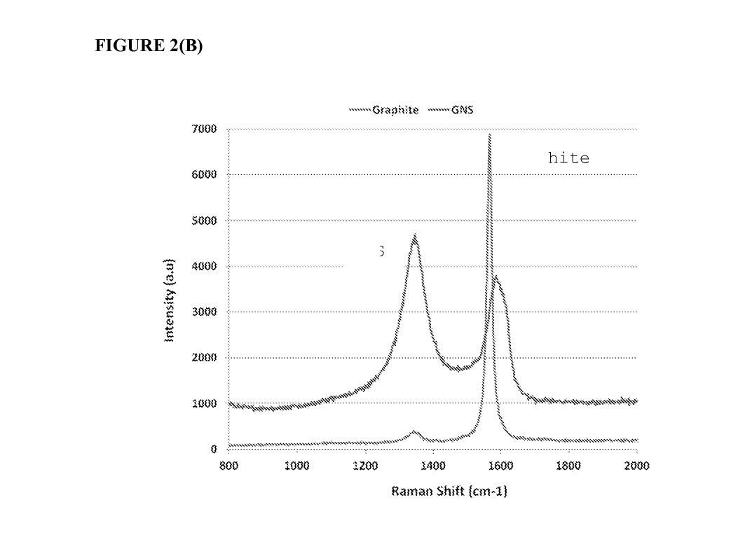

In order to examine the specific surface area and the pore size distribution of the as-prepared GNS and Ketjan Black carbon, N₂ adsorption desorption isotherm measurements were carried out using Micromeritics, Tristar III surface area and pore distribution analyzer. In FIG. 3(A), the GNS is shown to exhibit a typical IV shape, indicating their mesoporous characteristic. The pore size distribution, obtained from the Barrett-Joyner-Halenda (BJH) method, is shown in FIG. 3(A). The plot shows that the dominant peaks are in the mesoporous range with a peak around 6 nm. The surface area estimated from the Brunauer-Emmett-Teller (BET) method is 380 m²g⁻¹ and the pore volume is 5.39 cm³g⁻¹. The nitrogen adsorption/desorption isotherm of Ketjen Black carbon is shown in FIG. 3(B). The pore size distribution of Ketjen Black carbon exhibits a mesoporous structure with broad pore size distribution. The surface area estimated from the BET method is 1557.5 m²g⁻¹ and the pore volume is 10.5 cm³g⁻¹. The discharge capacity of lithium-air batteries is related to the available pore volume of the air electrode. The air electrode can accommodate more discharge products; the discharge time can be longer; and the discharge capacity can be higher if the available pore volume is larger. However, the pore volume and surface area of Pt-GNS was less than the GNS itself and depends on the temperature used to dry the Pt-GNS composite.

### Electrochemical Characterization

The electrocatalytic activity of GNS and KB for ORR and OER without catalysts added was examined in Li-air cells and compared with those with Pt catalysts added. The cell configuration was Swagelok type with a carbon coated on a 1.6 mm thick and 1 cm diameter Ni foam. The carbon loading on Ni foam was kept constant at 7±1 mg since the capacity initially increased with the increased carbon loading up to about 12 mg and then decreased drastically with increased carbon loading. The loading of catalyst on carbon was 10%.

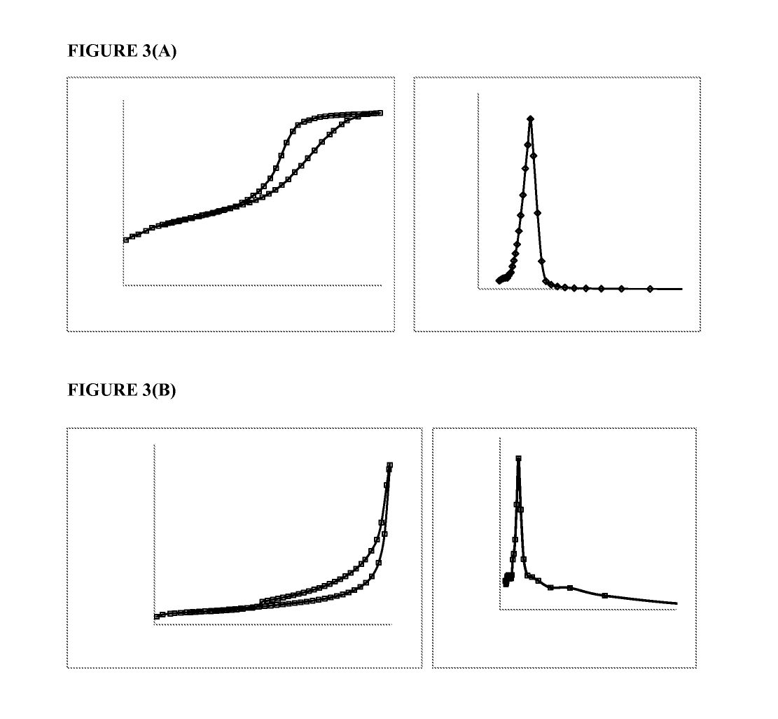

The discharge-charge cycle (first cycle) of Li-air cells constructed using graphene and KB are shown in FIG. 4. A discharge capacity of 2400 mAh/g with a nominal discharge voltage of 2.68 V was observed for KB (FIG. 4(A)), while for graphene a discharge capacity of 2000 mAh/g at a stable nominal discharge voltage of 2.80 V was observed at a constant current of 50 mA/g (FIG. 4(B)). This discharge capacity value for KB is comparable to the values reported using porous carbons. The lower discharge capacity of GNS compared to KB can be attributed to the lower surface area of synthesized GNS. However, the average charging voltage plateau obtained for GNS (3.9 V) is lower than the value obtained for KB (4.3 V) and values reported using porous carbon without any catalysts added. The voltaic efficiency (discharge voltage/charge voltage) for graphene and KB systems are 63% and 72% respectively.

Although it was reported that ORR kinetics in Li-air systems is not a catalytically sensitive reaction, or that the ORR kinetics is dominated by the high catalytic activity of different carbon materials, a higher discharge voltage of 2.85 V_{Li} was observed when GNS was used as carbon support. This could be due to the higher electrical conductivity of GNS compared to KB containing cells. The average charge voltage obtained for KB presented in FIG. 4(A) is 4.3 V, which is comparable with the values reported. Normally, the charging activity (OER or decomposition of Li₂O₂) of carbon is poor, with an average voltage plateau of 4.7 V_{Li}. The use of catalyzed high surface area carbon can reduced the activation overpotential associated with OER. Average charge voltages of 4.2 V_{Li} on MnO₂/C and 4.0 V_{Li} on gamma MnO₂, alpha MnO₂ nanowires have been observed for catalytic systems. The charge curve of the graphene based cell presented in FIG. 4(B) shows a charge voltage even less than 4 V_{Li} during the beginning and increased to 4.0 V Li during the latter part of the charge cycle. These observations clearly indicate that GNS catalyzes the OER in Li-air systems. Thus, GNS appears to be a chemically stable, high surface area support material for air cathodes with increased η_{dis}.

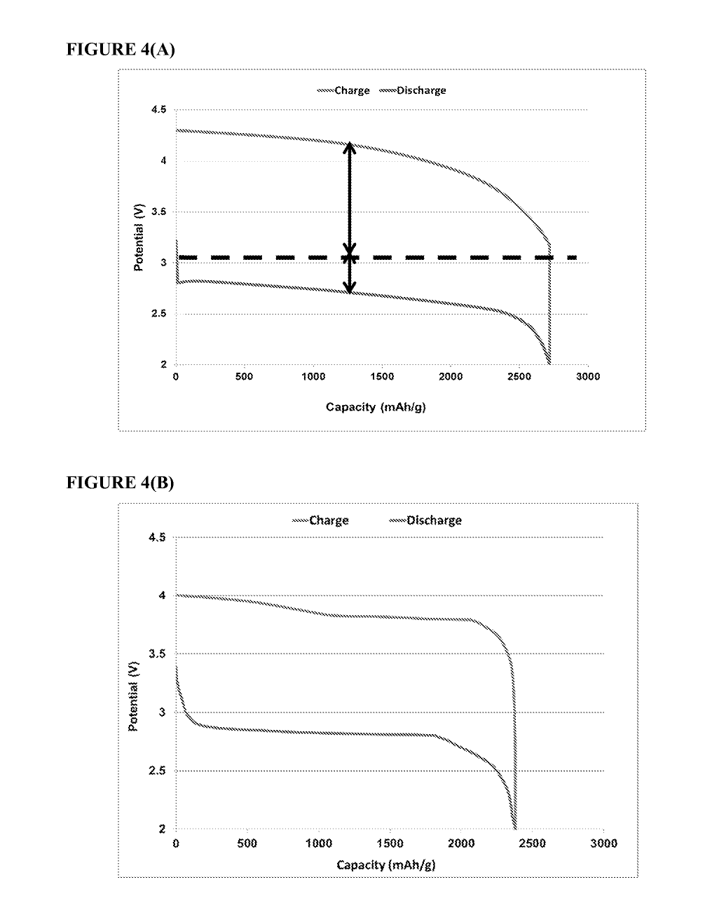

The cycling behavior of GNS and KB based cells without catalysts added are shown in FIG. 5. The current density used was 100 mA/g and the discharge cycles were terminated when the DoD was 60%. The first cycle discharge capacities at this high discharge rate were 1800 mA/g and 1400 mA/g for KB and GNS, respectively. The discharge capacity dropped to 1200 mA/g within five cycles (14% decreases), while the KB based cell showed a more dramatic capacity drop of 44% after five cycles. The voltaic efficiencies, also presented in FIG. 5, dropped moderately (from 72% to 60%) with the GNS based cell and drastically (from 63% to 30%) with the porous carbon based cell. Although the GNS based Li-air cells showed promising properties over conventional porous carbon based air cathodes, the voltaic efficiencies presented here are still not sufficient for practical applications. Therefore, the incorporation of bifunctional catalysts into GNS and the performance of an air cathode made out of these systems were investigated.

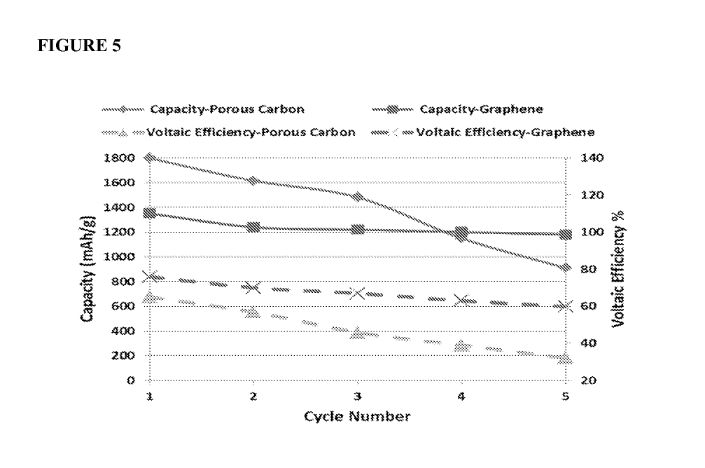

Bifunctional Au—Pt nano catalysts can greatly influence the discharge and charge voltages of Li-air batteries, where Au is the most active for ORR and Pt is the most active for OER. Since the problems of low cycle life and low voltaic efficiency are due to the slow kinetics of OER, nanoscale Pt was impregnated into GNS in order to understand the feasibility of using GNS as a support (host) for bifunctional catalysts. The in-situ incorporation of nanoscale Pt islands onto GNS was performed by simultaneous reduction of graphene oxide wet impregnated with hexachlorplatinic acid using 5% hydrogen in Ar at 450° C. The SEM image of the Pt-GNS composite with EDX spectrum is shown in FIG. 6(A) and the XRD peaks are shown in FIG. 6(B). The presence of Pt in GNS is characterized by the extra peaks in XRD spectrum. The peaks at 2θ=40, 46.2, 68° can be assigned to the (111), (200), and (220) crystalline planes of Pt, respectively, which indicates that the Pt particles are composed of pure crystalline Pt. As evidenced by these data, Pt is attached to GNS.

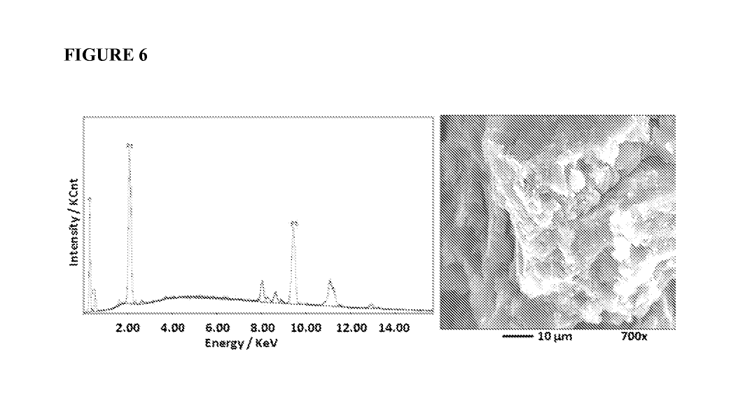

A Li-air cell made using these cathode materials showed higher electrical efficiency and high cycle life. The discharge capacities and total energy efficiency (voltaic×coulombic) for the Li-air cell comprising graphene, porous carbon and Pt/graphene cathode are shown in FIG. 7, where graphene demonstrates higher efficiency than conventional porous carbon. With the incorporation of Pt onto GNS, the electrical efficiency was about 80%, throughout the number of cycles tested (20 cycles). On the other hand, the voltaic efficiency and discharge capacity for the GNS only system was stable up to about nine cycles, but continuously decreased to 20% and below 400 mAh/g at the 20th cycle. These data suggested that graphene could be a superior support for bifunctional catalysts for Li-air batteries over conventional carbon.

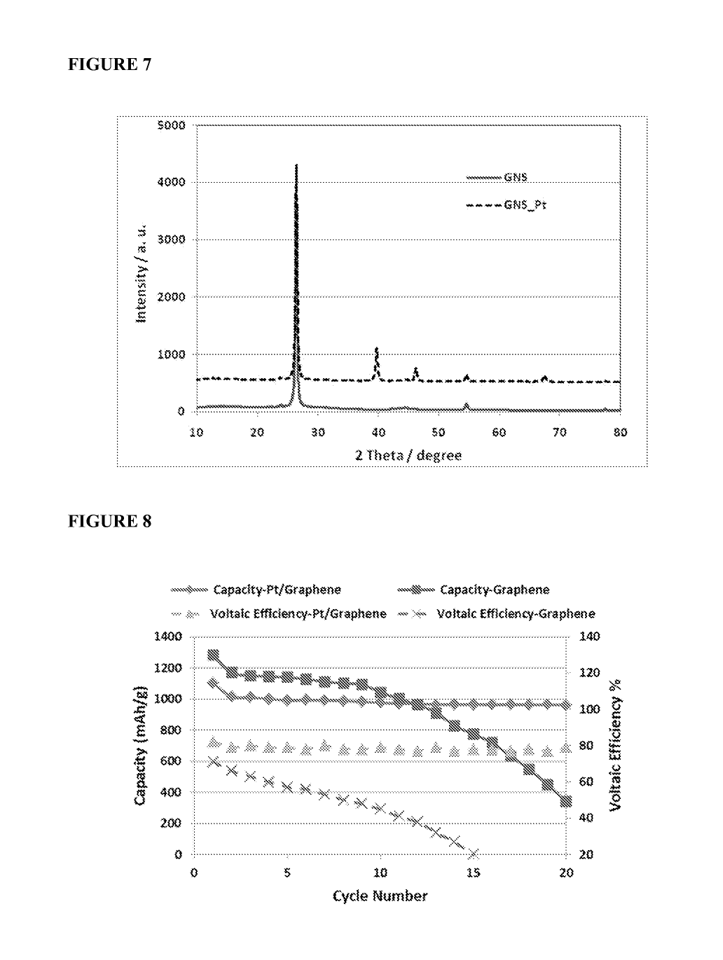

The use of Spinel and Perovskites mixed metal oxide as bifunctional catalyst for air electrodes for fuel cell applications in aqueous electrolytes has been studied extensively. However, the application of Perovskites type bifunctional catalysts in non-aqueous Li-air systems was not studied. Several low cost pervoskite type metal oxide catalyst systems have been synthesized and tested in Li-air single cells. The TEM image of La_{0.5}Ce_{0.5}Fe_{0.5}Mn_{0.5}O₃ on GNS (FIG. 8) shows that the catalyst particles were well embedded in GNS wrinkles. The size of the irregular shaped catalyst particles ranges from 10 nm to around 50 nm. A cell with the bifunctional catalyst of composition La_{0.5}Ce_{0.5}Fe_{0.5}Ni_{0.5}O₃ demonstrated up to 70 cycles without any significant capacity fading. However, the total electrical efficiency was less than 70%. The catalyst with the composition La_{0.5}Ce_{0.5}Fe_{0.5}Mn_{0.5}O₃ resulted in an even larger number of cycles with electrical efficiency greater than 75%.

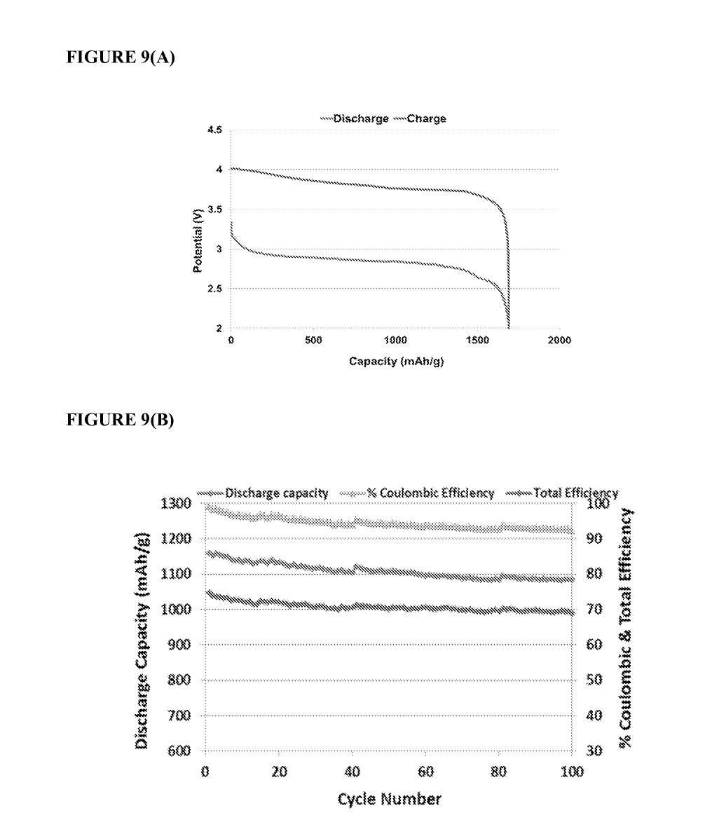

The discharge curve for a Li-Air cell with this optimized cathode configuration is shown in FIG. 9(A). The cathode material comprised 10 wt. % bifunctional catalyst, 2 wt. % binder and the rest GNS. A discharge capacity of 1200 mAh/g of cathode material at a stable nominal discharge voltage of 2.8 V was observed at a constant current of 50 mA/g. Several discharge-charge cycles for an identical Li-air cell at a constant current of 100 mA/g were carried out and the discharge capacity and energy efficiency as a function of cycle numbers were shown in FIG. 9(B). A charge voltage of about 3.8 volt was observed during the initial cycles; however this charge voltage increased gradually up to a value of 4.2 V at the end of 100 cycles. This gradual increase of charge voltage and gradual decrease of coulombic efficiency resulted in a decrease of electrical efficiency as shown in FIG. 9(B).

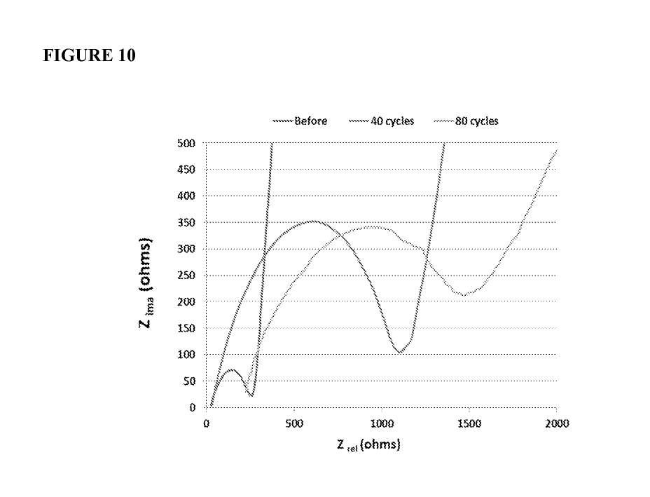

Electrochemical impedance spectroscopy (EIS) data collected before cycling, and after 40 and 80 discharge-charge cycles for the Li-air cell described in FIG. 9(B) is shown in FIG. 10. The increase of ohmic resistance, which includes ionic resistance of electrolyte and electrical resistance from both electrodes (represented by the high frequency intercept of the semi-circle on the real axis) and the increase of the charge transfer resistant (represented by the middle frequency depressed semicircles) as a function of cycle numbers were observed. The reasons for this increasing impedance could be due to the formation of SEI layer or clogging of pores within the carbon support which hinder the catalytic activity. Also, it was evident that the drying of electrolyte significantly contributes to the increased ohmic resistance between cycle numbers of 40 and 80. The volatilization of organic electrolyte as one of the main factors affecting the discharge capacity when the batteries discharge at low rates (longer times). The use of non-volatile electrolytes such as room temperature ionic liquids may improve the cycle life.

The examples disclosed in the present disclosure demonstrated the efficiency of the combination of GNS and La_{0.5}Ce_{0.5}Fe_{0.5}Ni_{0.5}O₃ bifunctional catalyst as cathode material for air electrode for the Li-air system. This Li-air system exhibited 100 cycles with a charge voltage less than 4 V, with a total efficiency of about 70%. Prevention of decomposition and drying of carbonate based electrolyte can further help improve the cyclability.

### Experimentals

Synthesis of Graphene Nanosheets and Anchoring of Nano-Pt onto GNS

The incorporation of nanoparticles of bifunctional catalysts onto GNS was performed by two methods: direct anchoring of catalysts during the synthesis of graphene from graphene oxide, or using impregnation and co-precipitation methods to load catalysts onto as-prepared GNS.

Graphite oxide (GO) was synthesized from flake graphite (Asbury Carbons, 230U Grade, High Carbon Natural Graphite 99+) by a modified Hummers' method originally reported by Kovtyukhova et al., Chem. Mater., 11, pp. 771-778 (1999), the entirety of which is hereby incorporated by reference. According to the Kovtyukhova method, pre-oxidation of graphite is followed by oxidation with Hummers' method. The pre-oxidation of the graphite power was carried out with concentrated H₂SO₄ solution in which K₂S₂O₈ and P₂O₅ were completely dissolved at 80° C. The pretreated product was filtered and washed on the filter until the pH of the filtrate water became neutral. The shiny, dark-gray, pre-oxidized graphite was dried in air overnight. The final oxidation of pre-oxidized graphite was performed by the reaction of pre-oxidized graphite dispersed in chilled H₂SO₄ with slow addition of KMnO₄ at a temperature below 20° C. The resulting thick, dark green paste was allowed to react at 35° C. for 2 hours followed by addition of DI water to give a dark brown solution. After additional stirring for 2 hours, the dark brownish solution was further diluted with distilled water after which H₂O₂ was added slowly until the color of the mixture turned into brilliant yellow. The mixture was allowed to settle overnight and the supernatant was decanted. The remaining product was washed with 10% HCl solution with stirring and the brownish solution was allowed to settle overnight. The supernatant was decanted and the remaining product was centrifuged and washed with DI water.

Pt nanoparticles on graphene nanosheets were synthesized by the ethylene glycol reduction (EG) method as reported by Z. S. Wu et al., ACS Nano. 4, pp. 3187-3194 (2010), the entirety of which is hereby incorporated by reference. In a typical synthesis, stoichiometric amounts of metal precursors (H₂PtCl₆ as Pt precursor) dispersed in 40 mL ethylene glycol solution and 160 mg GO dispersed in 40 mL ethylene glycol solution were mixed together in a 125 mL round-bottom flask equipped with a N₂ in/outlet. The resulting suspension was refluxed at 403 K for 3 hours. The composite mixture was then sonicated for two hours and then vacuum-filtered until the surface of the composite appeared dry. Then it was washed copiously with acetone and dried at 333 K in a vacuum oven. Finally, the catalyst-GNS composite was heat treated at 473 K under Ar—H₂ (9:1 v/v) gas atmosphere for 2 hours. For comparison, Ketjan Black-supported Pt was also prepared by a wet impregnation method, which is a commonly used technique for the synthesis of heterogeneous catalysts. The Pt precursor was dissolved in an aqueous solution in an equal volume of predetermined water uptake. Then the metal-containing solution was added to a catalyst support (GNS or KB) containing the same pore volume as the volume of the solution that was added). The nominal Pt content on both the graphene and Ketjen Black was 10 wt. % each.

Synthesis of Bifunctional Catalysts and Anchoring of Catalysts onto GNS

Perovskite type catalyst, La_{0.5}Ce_{0.5}Fe_{0.5}Mn_{0.5}O₃, was prepared by a co-precipitation method mixing stoichiometric amounts of corresponding nitrate compounds in DI water. The precursors (nitrates of La, Ce, Fe and Mn) were separately mixed in an aqueous solution, and this mixed metal solution was added drop-wise to a new container with an aqueous solution of ammonia to reach a pH value of about 10. The precipitates were filtered, washed with DI water until no pH change could be detected, dried at 110° C. overnight and then calcined in air at 500° C. for 2 hours. Synthesized bifunctional catalysts were loaded onto GNS by physical mixing during the slurry preparation as described in the following paragraph.

### Slurry and Air Cathode Preparation

A slurry was prepared using the procedure described by Beattie et al., J. Electrochem. Soc., 156 pp. A44-47 (2009), the entirety of which is hereby incorporated by reference. Specifically, the slurry was prepared by mixing catalyst anchored carbon powders (GNS or KB) with 5% PVDF (average MW 534000 GPC, Sigma-Aldrich)/N-methylpyrolidone (NMP, 99.5%, Sigma-Aldrich) binder mixture and homogenized with a pestle and mortar. Circular disks (1 cm diameter and 1.6 mm thick) were cut from sheets of Nickel foam (Goodfellow Corporation) and submerged in the NMP/PVDF/carbon slurry. The disks were sonicated to improve penetration of the carbon matrix on Ni foam. NMP solvent was removed by vacuum drying the carbon coated Ni foam at 110° C. for 12 hours. The PVDF binder amount in the final cathode was 10%.

### Material Characterization

Raman spectroscopy, BET surface area and pore size distribution analyzer (Micromeritics, Tristar III), and SEM were used to characterize as prepared GNS, catalyst/GNS composite, and catalyst/commercial graphene composite. Catalyst composition and structure were analyzed by SEM-EDX and XRD.

### Li-Air Single Cell Construction and Electrochemical Characterization

The cell comprised lithium metal foil as the anode, a 250 μm thick Celgard fiber separator, and a porous cathode constructed from various combinations of carbon matrices and catalyst. 1M LiPF₆ in 1:1 ethylene carbonate: dimethylcarbonate mixture was used as electrolyte. The cell construction was of a spring loaded Swagelok design with active electrode areas of 1.2 cm². The cell was assembled in an argon-filled glove box with <1 ppm O₂ and moisture content.

Electrochemical cycling of the assembled cells was done galvanostatically with a cut-off voltage range of 2.0 V-4.8 V while maintaining a constant current density. Electrochemical tests were performed under controlled atmospheric conditions using dry oxygen. To determine the maximum capacity, the first cell was subjected to ˜3-5 charge-discharge cycles at a constant current density of 70 mA/g cathode material. The second cell was used to evaluate for cycle performance using the same rate up to the 60% depth of discharge (DoD) limit. The irreversible capacity loss, Coulombic and voltaic efficiency of the cell were recorded as a function of number of charge-discharge cycles. The same cell was subjected to electrochemical impedance spectroscopy (EIS) measurements at the 0.1-10⁶ Hz frequency range in order to measure the internal resistance build up during discharge-charge cycles.

Rechargeable lithium-air batteries offer great promise for transportation and stationary applications due to their high specific energy and energy density compared to all other battery chemistries. Although the theoretical discharge capacity of the Li-air cell is extremely high, the practical capacity is much lower and is always cathode limited. A factor for rechargeable systems is the development of an air electrode with a bifunctional catalyst on an electrochemically stable carbon matrix.

According to one embodiment of the present disclosure, graphene was used as a stable catalyst matrix for the air cathode. The Li-air cell constructed using an air cathode consisting of nano Pt on graphene nanosheets (GNS) showed promising performance at 80% energy efficiency with an average capacity of 1200 mAh/g and more than 20 cycles without significant loss of total energy efficiency. Replacement of Pt with a nano structured Perovskite type bifunctional catalyst resulted in more than 100 cycles with an average capacity of 1200 mAh/g and total energy efficiency of about 70%.

The novel catalysts of the present disclosure can be used for any purpose. For example, one application of these catalysts is to be used to prepare Li-air batteries. The present disclosure provides novel highly efficient, low cost battery technologies for large scale energy storage, which overcomes the high cost, technical challenges, and environmental hazards related to traditional technologies, such as lead acid and nickel cadmium batteries.

The efficiency, cycle life and capacity of the Li-air batteries according to one embodiment of the present disclosure can be further improved by exploring the relationship of particle size, catalyst composition, synthesis route and attachment of the nanoscale catalyst onto graphene and the impact of these factors on the electrochemical performance. The synthesis route can be optimized in order to further reduce the particle size and the related improvement in the overall characteristics of the air cathode.

While the present disclosure has been described with reference to certain embodiments, other features may be included without departing from the spirit and scope of the present disclosure. It is therefore intended that the foregoing detailed description be regarded as illustrative rather than limiting, and that it be understood that it is the following claims, including all equivalents, that are intended to define the spirit and scope of this invention.

1. A metal-air battery, comprising:
a metal anode,
a cathode,
an electrolyte disposed between the metal anode and the cathode, and
a catalyst on the cathode, the catalyst reducing both the charge overpotential and discharge overpotential of the battery, wherein the catalyst is disposed on a graphene support.

2. The metal-air battery of claim 1, wherein the metal anode is selected from the group consisting of Fe, Zn, Al, Mg, Ca, Li, and combinations thereof.

3. The metal-air battery of claim 1, wherein the metal anode comprises Li.

4. The metal-air battery of claim 1, wherein the metal anode comprises a lithium metal foil.

5. The metal-air battery of claim 1, wherein the cathode is a porous cathode.

6. The metal-air battery of claim 5, wherein the porous cathode comprises large surface area carbon with a surface area in the range of about 200-3000 m²/g

7. The metal-air battery of claim 5, wherein the porous cathode and the graphene support comprise the same material.

8. The metal-air battery of claim 1, wherein the graphene support comprises graphene nanosheets.

9. The metal-air battery of claim 1, wherein the catalyst is selected from the group consisting of Pt, Au, Ag, and the combinations thereof.

10. The metal-air battery of claim 1, wherein the catalyst is Pt.

11. The metal-air battery of claim 10, wherein the catalyst is Pt nanoparticles.

12. The metal-air battery of claim 1, wherein the catalyst is Au.

13. The metal-air battery of claim 1, wherein the catalyst is Pt and Au.

14. The metal-air battery of claim 1, wherein the catalyst is AₘBₙOₚ, wherein m is 1-5, n is 1-5 and p is 1-5, and wherein A is a divalent metal or rare earth element and B is a tetrahedral metal.

15. The metal-air battery of claim 14, wherein each A is independently selected from the group consisting of Ce, Ca, Sr, Pb, and any rare earth element, and wherein each B is independently selected from the group consisting of Ti, Fe, Ni, and Mo.

16. The metal-air battery of claim 15, wherein the catalyst comprises Ce.

17. The metal-air battery of claim 1, wherein the catalyst comprises La₁₋ₓCeₓFe_{1-y}Mn_{y}O₃, wherein x is 0-1 and y is 0-1.

18. The metal-air battery of claim 17, wherein the catalyst comprises La_{0.5}Ce_{0.5}Fe_{0.5}Mn_{0.5}O₃.

19. A catalyst, comprising:
a metal selected from the group consisting of Pt, Au, and combinations thereof, wherein the metal is capable of reducing both the charge overpotential and discharge overpotential of a metal-air battery, and
a graphene support on which the metal is disposed.

20. The catalyst of claim 19, wherein the graphene support comprises graphene nanosheets.

21. The catalyst of claim 19, wherein the metal is Pt.

22. The catalyst of claim 19, wherein the metal is Au.

23. The catalyst of claim 19, wherein the metal is Pt and Au.

24. A catalyst, comprising:
a composition of formula, AₘBₙOₚ, wherein m is 1-5, n is 1-5 and p is 1-5, and wherein A is a divalent metal or rare earth element and B is a tetrahedral metal, wherein the composition is capable of reducing both the charge overpotential and discharge overpotential of a metal-air battery, and
a graphene support on which the composition is disposed.

25. The catalyst of claim 24, wherein each A is independently selected from the group consisting of Ce, Ca, Sr, Pb, and any rare earth element.

26. The catalyst of claim 24, wherein each B is independently selected from the group consisting of Ti, Fe, Ni, and Mo.

27. The catalyst of claim 24, wherein the composition comprises Ce.

28. The catalyst of claim 24, wherein the composition comprises La₁₋ₓCeₓFe_{1-y}Mn_{y}O₃, wherein x is 0-1 and y is 0-1.

29. The catalyst of claim 24, wherein the composition comprises La_{0.5}Ce_{0.5}Fe_{0.5}Mn_{0.5}O₃.
